(19) United States
(12) Patent Application Publication
(10) Pub. No.: US 2012/0044570 A1
(43) Pub. Date: Feb. 23, 2012

(54) INTERFERENCE FILTER, OPTICAL MODULE, AND ANALYSIS DEVICE

(75) Inventors: Koji KITAHARA, Ina (JP); Susumu SHINTO, Suwa (JP)

(73) Assignee: SEIKO EPSON CORPORATION, Tokyo (JP)

(21) Appl. No.: 13/210,013

(22) Filed: Aug. 15, 2011

(30) Foreign Application Priority Data
Aug. 18, 2010 (JP) 2010-182939

(51) Int. Cl. G02B 5/28

(52) U.S. Cl. 359/589

(57) ABSTRACT

An interference filter includes two reflective films that are opposed to each other with a gap interposed therebetween and substrates that support the corresponding reflective films. The reflective films each include a pure silver film and a silver alloy film. The pure silver film and the silver alloy film are formed on the corresponding substrate sequentially from the substrate. The silver alloy film is one of an Ag—Sm—Cu alloy film containing silver (Ag), samarium (Sm), and copper (Cu) and an Ag—Bi—Nd alloy film containing silver (Ag), bismuth (Bi), and neodymium (Nd).

### BACKGROUND

1. Technical Field

The present invention relates to an interference filter, an optical module having the interference filter, and an analysis device having the optical module.

2. Related Art

Interference filters in which mirrors as reflective films are disposed on opposed surfaces of a pair of substrates so as to face each other have been known. Each of such interference filters includes a pair of substrates kept parallel to each other and a pair of mirrors (reflective films) formed on the pair of substrates with a constant gap interposed therebetween so as to face each other.

The interference filters transmit only light of a specific wavelength out of incident light by reflecting light between a pair of mirrors to transmit only a light beam of a specific wavelength and to cancel light beams of the other wavelengths by interference.

A dielectric film or a metal film is used for the mirrors. The mirrors require a high reflection characteristic and a transmission characteristic as functions. In consideration of such functions, silver (Ag) is a strong candidate for the metal film.

However, a film (Ag film which is also referred to as a pure silver film) formed of Ag is low in high-temperature resistance or process resistance. Process resistance means resistance to processing conditions in a patterning process performed to pattern the mirrors in a desired shape after the formation of the film. Examples of the processing conditions include a high-temperature baking process or a resist peeling process using an organic solvent. The deterioration in reflectance of the Ag film having been subjected to the processes is great and the functions required for the mirrors are not satisfactorily exhibited, thereby causing deterioration in performance of the interference filter. The deterioration in reflectance of the Ag film due to a time-dependent change is also great.

Materials used for the mirrors have been studied in this background.

For example, JP-A-2009-251105 describes an interference filter in which an Ag—C alloy obtained by adding carbon (C) to pure silver is used for a mirror.

However, even when the Ag—C alloy film described in JP-A-2009-251105 is used for a mirror, deterioration in performance of the interference filter is caused. When the Ag—C alloy film is used for the mirrors of the interference filter, the high-temperature resistance or the process resistance is more excellent than when a pure silver film is used, but deterioration in reflectance is caused. When the thickness of the Ag—C alloy film is increased to improve reflectance, the transmittance thereof is decreased such as to reduce the detection sensitivity of the filter. Therefore, there is a need for an interference filter with suppressed deterioration in filter performance.

### SUMMARY

An advantage of some aspects of the invention is that it provides an interference filter with suppressed deterioration in performance, an optical module which has the interference filter, and an analysis device which has the optical module.

An aspect of the invention is directed to an interference filter including: two reflective films that are opposed to each other with a gap interposed therebetween; and substrates that support the corresponding reflective films. Here, the reflective films each include a pure silver film and a silver alloy film, and the pure silver film and the silver alloy film are formed on the corresponding substrate sequentially from the substrate. The silver alloy film is one of an Ag—Sm—Cu alloy film containing silver (Ag), samarium (Sm), and copper (Cu) and an Ag—Bi—Nd alloy film containing silver (Ag), bismuth (Bi), and neodymium (Nd).

The reflective films in the interference filter have a transmission characteristic of transmitting light and a reflection characteristic of reflecting light. For example, light incident between two (a pair of) reflective films through one reflective film from the outside is reflected between the reflective films and a light beam of a specific wavelength is transmitted by one or the other reflective film.

According to this aspect, two (a pair of) reflective films each include a pure silver film and a silver alloy film. Accordingly, it is possible to suppress the deterioration in reflectance, which is caused when the reflective films are formed of a single layer of a silver alloy film (a reflective film formed of only a silver alloy film), and to approach the reflectance of a single layer of a pure silver film (a reflective film formed of only a pure silver film).

Sequentially from the substrate, the pure silver film and the silver alloy film, which is more excellent in high-temperature resistance or process resistance than pure silver, are formed on the substrate. Accordingly, since the pure silver film is covered with the silver alloy film, the deterioration in reflectance due to processes or time-dependent change is smaller than that of the single layer of a pure silver film.

As a result, it is possible to suppress deterioration in performance of the interference filter.

Another aspect of the invention is directed to an interference filter including: two reflective films that are opposed to each other with a gap interposed therebetween; and substrates that support the corresponding reflective films. Here, the reflective films each include a pure silver film and a silver alloy film, and the pure silver film and the silver alloy film are formed on the corresponding substrate sequentially from the substrate. The silver alloy film is one of an Ag—Au alloy film containing silver (Ag) and gold (Au), an Ag—Cu alloy film containing silver (Ag) and copper (Cu), an Ag—Au—Cu alloy film containing silver (Ag), gold (Au), and copper (Cu), an Ag—Si—Cu alloy film containing silver (Ag), silicon (Si), and copper (Cu), an Ag—P—Cu alloy film containing silver (Ag), phosphorus (P), and copper (Cu), an Ag—P—In—Cu alloy film containing silver (Ag), phosphorus (P), indium (In), and copper (Cu), an Ag—Te—Cu alloy film containing silver (Ag), tellurium (Te), and copper (Cu), an Ag—Ga—Cu alloy film containing silver (Ag), gallium (Ga), and copper (Cu), and an Ag—In—Sn alloy film containing silver (Ag), indium (In), and tin (Sn).

According to this aspect, similarly to the above-mentioned aspect, since two (a pair of) reflective films each include the pure silver film and the silver alloy film, it is possible to allow the reflectance of the reflective films to approach the reflectance of a single layer of the pure silver film.

Since the silver alloy film is formed to cover the pure silver film, it is possible to suppress the deterioration in reflectance due to processes or time-dependent change.

As a result, it is possible to suppress deterioration in performance of the interference filter.

In the interference filter, the thickness of each reflective film may be in the range of 30 nm to 80 nm, and the thickness of the silver alloy film may be equal to or greater than 10 nm.

According to this configuration, the thickness of each reflective film of the interference filter is in the range of 30 nm to 80 nm and the thickness of the silver alloy film is equal to or greater than 10 nm. Accordingly, the thickness of the reflective film is not excessively great and the deterioration in transmittance is suppressed, thereby preventing the deterioration in performance of the interference filter. Since the high-temperature resistance or the process resistance is given to the reflective films by the silver alloy film, the variation in transmittance due to processes or time-dependent change is suppressed. As a result, it is possible to suppress the deterioration in the two characteristics of reflection and transmission of light, which is required for the reflective films of the interference filter.

In the interference filter, the silver alloy film may be an Ag—Sm—Cu alloy film. Here, the Sm content in the Ag—Sm—Cu alloy film may be in the range of 0.1 at % to 0.5 at %, the Cu content may be in the range of 0.1 at % to 0.5 at %, and the total content of Sm and Cu may be equal to or less than 1 at %.

According to this configuration, since the Ag—Sm—Cu alloy film has the above-mentioned composition, it is possible to further suppress the deterioration in reflectance due to processes or time-dependent change and thus to more satisfactorily suppress the deterioration in performance of the interference filter. When the contents of Sm and Cu are less than 0.1 at %, the deterioration in reflectance due to processes or time-dependent change increases. When the contents of Sm and Cu are greater than 0.5 at %, the reflectance is lowered. When the total content of Sm and Cu is greater than 1 at %, the reflectance is lowered.

In the interference filter, the silver alloy film may be an Ag—Bi—Nd alloy film. Here, the Bi content in the Ag—Bi—Nd alloy film may be in the range of 0.1 at % to 3 at % and the Nd content may be in the range of 0.1 at % to 5 at %.

According to this configuration, since the Ag—Bi—Nd alloy film has the above-mentioned composition, it is possible to further suppress the deterioration in reflectance due to processes or time-dependent change and thus to more satisfactorily suppress the deterioration in performance of the interference filter. When the contents of Bi and Nd are less than 0.1 at %, the deterioration in reflectance due to processes or time-dependent change increases. When the Bi content is greater than 3 at % or when the Nd content is greater than 5 at %, the reflectance is lowered.

In the interference filter, when the silver alloy film is the Ag—Au alloy film, the Au content may be in the range of 0.1 at % to 10 at %. When the silver alloy film is the Ag—Cu alloy film, the Cu content may be in the range of 0.1 at % to 10 at %. When the silver alloy film is the Ag—Au—Cu alloy film, the Au content may be equal to or greater than 0.1 at %, the Cu content may be equal to or greater than 0.1 at %, and the total content of Au and Cu may be equal to or less than 10 at %. When the silver alloy film is the Ag—Si—Cu alloy film, the Si content may be equal to or greater than 0.1 at %, the Cu content may be equal to or greater than 0.1 at %, and the total content of Si and Cu may be equal to or less than 10 at %. When the silver alloy film is the Ag—P—Cu alloy film, the P content may be equal to or greater than 0.1 at %, the Cu content may be equal to or greater than 0.1 at %, and the total content of P and Cu may be equal to or less than 10 at %. When the silver alloy film is the Ag—P—In—Cu alloy film, the P content may be equal to or greater than 0.1 at %, the In content may be equal to or greater than 0.1 at %, the Cu content may be equal to or greater than 0.1 at %, and the total content of P, In, and Cu may be equal to or less than 10 at %. When the silver alloy film is the Ag—Te—Cu alloy film, the Te content may be equal to or greater than 0.1 at %, the Cu content may be equal to or greater than 0.1 at %, and the total content of Te and Cu may be equal to or less than 10 at %. When the silver alloy film is the Ag—Ga—Cu alloy film, the Ga content may be equal to or greater than 0.1 at %, the Cu content may be equal to or greater than 0.1 at %, and the total content of Ga and Cu may be equal to or less than 10 at %. When the silver alloy film is the Ag—In—Sn alloy film, the In content may be equal to or greater than 0.1 at %, the Sn content may be equal to or greater than 0.1 at %, and the total content of In and Sn may be equal to or less than 10 at %.

According to this configuration, since the alloy film has the above-mentioned compositions, it is possible to further suppress the deterioration in reflectance due to processes or time-dependent change and thus to more satisfactorily suppress the deterioration in performance of the interference filter. When the contents of the elements (Au, Cu, Si, P, In, Te, Ga, and Sn) contained in the alloy film are less than 0.1 at %, the deterioration in reflectance due to processes or time-dependent change increases. When the total content of the elements contained in the alloy film is greater than 10 at %, the reflectance is lowered.

In the interference filter, each of the reflective films may include a dielectric film, the pure silver film, and the silver alloy film. Here, the dielectric film, the pure silver film, and the silver alloy film may be stacked on the corresponding substrate sequentially from the substrate.

According to this configuration, since the reflective film includes the dielectric film, it is possible to enhance the reflectance on a short wavelength side in the visible ray wavelength range, compared with the case where the dielectric film is not provided. In the configuration, the visible ray wavelength range is from 400 nm to 700 nm.

In the interference filter, the dielectric film may be one of a single-layered film of titanium oxide (TiO₂) and a multi-layered film in which a layer of titanium oxide (TiO₂) or tantalum pentoxide (Ta₂O₅) and a layer of silicon oxide (SiO₂) or magnesium fluoride (MgF₂) are stacked.

According to this configuration, since the dielectric film is formed of the above-mentioned compounds, it is possible to satisfactorily enhance the reflectance on a short wavelength side.

In the interference filter, each of the reflective films may include the dielectric film, the pure silver film, the silver alloy film, and a protective film. Here, the dielectric film, the pure silver film, the silver alloy film, and the protective film may be stacked on the corresponding substrate sequentially from the substrate.

According to this configuration, since the pure silver film and the silver alloy film are covered with the protective film, it is possible to further suppress the deterioration in reflectance of the pure silver film and the silver alloy film in the reflective film due to processes or time-dependent change. Accordingly, it is possible to more satisfactorily suppress the deterioration in performance of the interference filter.

In the interference filter, the protective film may contain one of silicon oxide (SiO₂), silicon oxynitride (SiON), silicon nitride (SiN), and alumina.

According to this configuration, since the protective film is formed of the above-mentioned compounds, it is possible to satisfactorily suppress the deterioration in reflectance due to processes or time-dependent change.

Still another aspect of the invention is directed to an optical module including: the above-mentioned interference filter; and a detection unit that detects the light intensity of light extracted by the interference filter.

According to this aspect, since the interference filter has reflectance close to that of pure silver, it is possible to suppress the deterioration in performance thereof, as described above. Accordingly, it is possible to allow the detection unit to detect the light extracted by the interference filter. As a result, the optical module can accurately detect the light intensity of light of a desired wavelength.

Yet another aspect of the invention is directed to an analysis device including a processing unit that performs an optical analysis process on the basis of the light intensity of light detected by the detection unit.

Here, examples of the analysis device include a photometer that analyzes the chromaticity or brightness of light incident on the interference filter on the basis of the light intensity of light detected by the optical module, a gas detecting device that detects the absorption wavelength of gas and inspects the type of gas, and an optical communication device that acquires data contained in light of the wavelength from the received light.

According to this aspect, it is possible to detect the light intensity of light of a desired wavelength by the use of the optical module, as described above. Accordingly, it is possible to perform an accurate analysis process on the basis of the accurately detected light intensity.

### BRIEF DESCRIPTION OF THE DRAWINGS

The invention will be described with reference to the accompanying drawings, wherein like numbers reference like elements.

FIG. 1 is a diagram schematically illustrating the configuration of a colorimetric device according to a first embodiment of the invention.

FIG. 2 is a plan view schematically illustrating the configuration of an etalon constituting an interference filter according to the first embodiment.

FIG. 3 is a sectional view taken along arrow line III-III of the interference filter in FIG. 2.

FIG. 4 is a sectional view schematically illustrating the configuration of an etalon constituting an interference filter according to a second embodiment of the invention.

FIG. 5 is a sectional view schematically illustrating the configuration of an etalon constituting an interference filter according to a third embodiment of the invention.

### DESCRIPTION OF EXEMPLARY EMBODIMENTS

Hereinafter, exemplary embodiments of the invention will be described with reference to the accompanying drawings.

### First Embodiment

### 1. Entire Configuration of Colorimetric Device

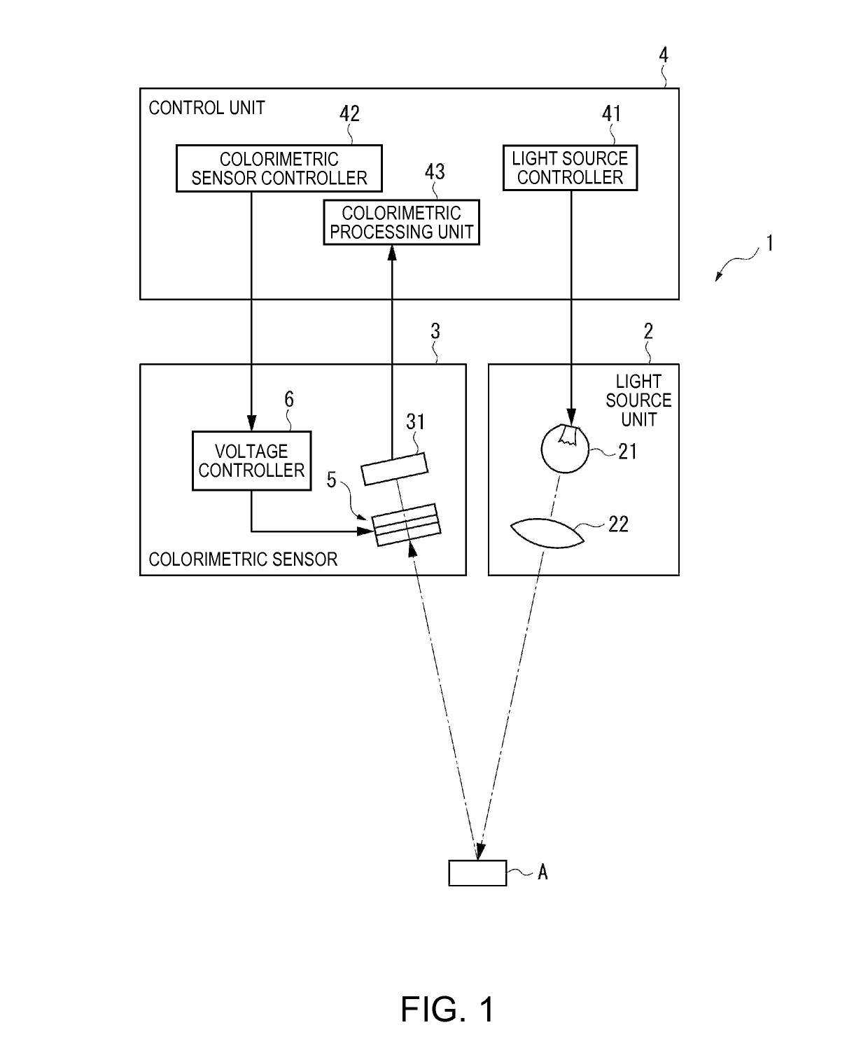

FIG. 1 is a diagram schematically illustrating the configuration of a colorimetric device according to a first embodiment of the invention.

The colorimetric device 1 is an example of the analysis device described in the claims and includes a light source unit 2 that emits light to a test object A, a colorimetric sensor 3 that is the optical module described in the claims, and a control unit 4 that controls the entire operation of the colorimetric device 1, as shown in FIG. 1. The colorimetric device 1 is a device that causes the test object A to reflect light emitted from the light source unit 2, receives the reflected test object light by the use of the colorimetric sensor 3, and analyzes and measures the chromaticity of the test object light, that is, the color of the test object A, on the basis of a detection signal output from the colorimetric sensor 3.

### 2. Configuration of Light Source Unit

The light source unit 2 includes a light source 21 and plural lenses 22 (only one of which is shown in FIG. 1) and emits white light to the test object A. The plural lenses 22 include a collimator lens and the light source unit 2 converts the white light emitted from the light source 21 into parallel light by the use of the collimator lens and emits the parallel light to the test object A through a projection lens not shown.

In this embodiment, the colorimetric device 1 having the light source unit 2 is described, but the light source unit 2 may not be provided, for example, when the test object A is a light-emitting member such as a liquid crystal panel.

### 3. Configuration of Colorimetric Sensor

As shown in FIG. 1, the colorimetric sensor 3 includes an etalon 5 constituting the interference filter described in the claims, a detection unit 31 receiving light passing through the etalon 5, and a voltage controller 6 changing the wavelength of light transmitted by the etalon 5. The colorimetric sensor 3 further includes an incidence optical lens (not shown) guiding the reflected light (test object light) reflected by the test object A to the inside thereof. The etalon 5 disperses only a light beam of a desired wavelength out of the test object light incident from the incidence optical lens. In the colorimetric sensor 3, the detection unit 31 receives the light dispersed by the etalon 5.

The detection unit 31 includes plural photoelectric conversion elements and generates an electrical signal corresponding to the received light intensity. The detection unit 31 is connected to the control unit 4 and outputs the generated electrical signal as a light-reception signal to the control unit 4.

### 3-1. Configuration of Etalon

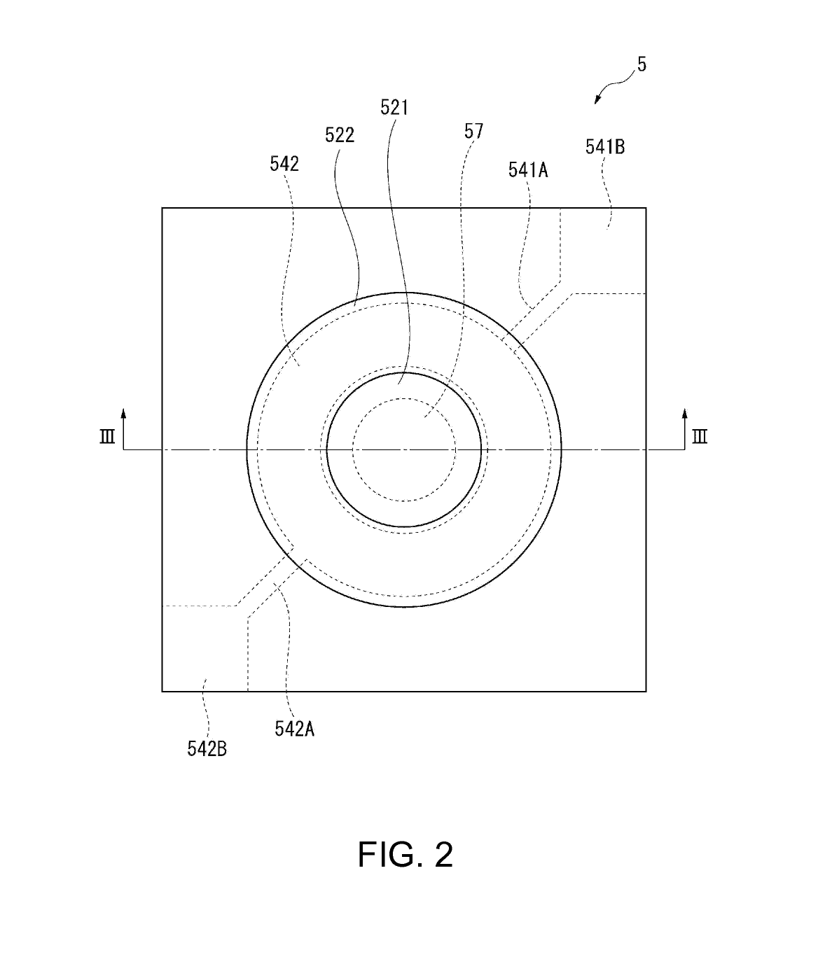

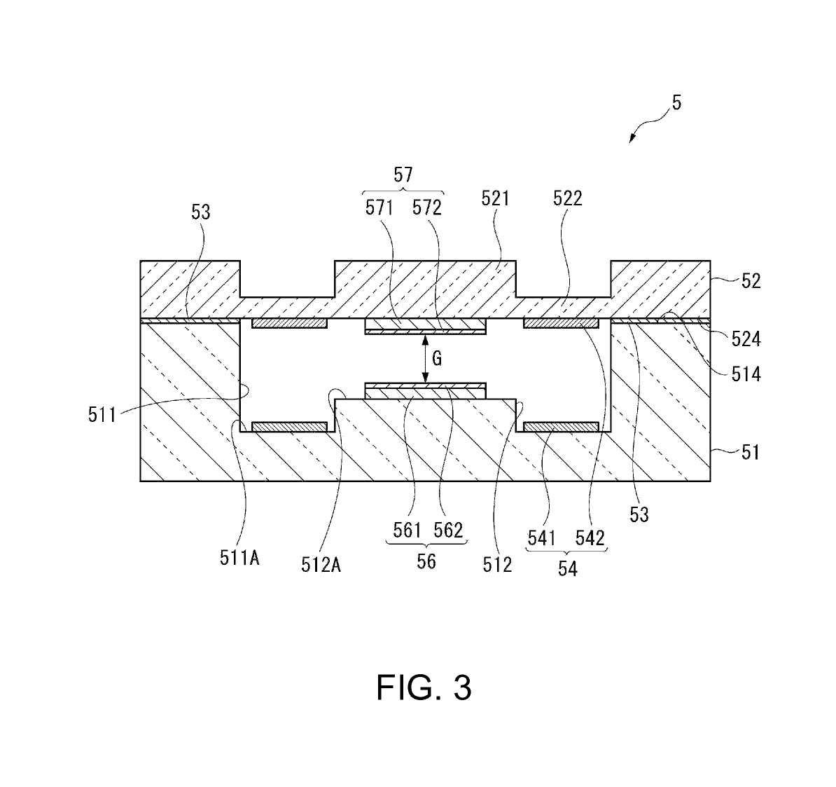

FIG. 2 is a plan view schematically illustrating the configuration of the etalon 5 constituting the interference filter described in the claims and FIG. 3 is a sectional view schematically illustrating the configuration of the etalon 5. The test object beam is incident on the etalon 5 from the downside in FIG. 1, but the test object beam is incident on the etalon from the upside in FIG. 3. The etalon 5 is a so-called wavelength-variable interference filter that changes the size of a gap between two (a pair of) mirrors by the use of an external force.

As shown in FIG. 2, the etalon 5 is a square planar plate-like optical member and has a side of, for example, 10 mm. The etalon 5 includes two (a pair of) substrates as shown in FIG. 3, which are referred to as a first substrate 51 and a second substrate 52 in this embodiment.

A fixed mirror 56 and a movable mirror 57 as a pair of reflective films are disposed between the first substrate 51 and the second substrate 52.

The fixed mirror 56 as one reflective film is disposed on the first substrate 51 and the movable mirror 57 as the other reflective film is disposed on the second substrate 52. Here, the fixed mirror 56 is fixed to a surface of the first substrate 51 facing the second substrate 52 and the movable mirror 57 is fixed to a surface of the second substrate 52 facing the first substrate 51. The fixed mirror 56 and the movable mirror 57 are disposed to face each other with an inter-mirror gap G interposed therebetween.

An electrostatic actuator 54 used to adjust the inter-mirror gap G between the fixed mirror 56 and the movable mirror 57 is disposed between the first substrate 51 and the second substrate 52. The electrostatic actuator 54 includes a first displacement electrode (fixed electrode) 541 disposed on the first substrate 51 and a second displacement electrode (movable electrode) 542 disposed on the second substrate 52. These electrodes are disposed to face each other. When a voltage is applied to the first displacement electrode 541 and the second displacement electrode 542, an electrostatic attractive force acts between the first displacement electrode 541 and the second displacement electrode 542 and thus the second substrate 52 is deformed, whereby the size of the inter-mirror gap G is changed. The wavelength of the light emitted from the etalon 5 is changed depending on the size of the inter-mirror gap G.

The detailed configuration of the etalon 5 will be described later and the fixed mirror 56 and the movable mirror 57 as a pair of reflective films will be described below.

### 3-1-1. Configuration of Pair of Reflective Films

In this embodiment, the fixed mirror 56 as one reflective film of the pair of reflective films includes a pure silver film 561 and a silver alloy film and the movable mirror 57 as the other reflective film includes a pure silver film 571 and a silver alloy film 572. As shown in FIG. 3, the fixed mirror 56 has a structure in which the pure silver film 561 and the silver alloy film 562 are stacked sequentially from the first substrate 51. Similarly, the movable mirror 57 has a structure in which the pure silver film 571 and the silver alloy film 572 are stacked sequentially from the second substrate 52.

The pure silver films 561 and 571 are films substantially formed of silver (Ag) without containing other added ingredients, unlike the silver alloy film. However, the pure silver films may contain a minute amount of impurity elements (for example, oxygen and nitrogen) in addition to the silver element without damaging the operational effect of the invention.

The silver alloy films 562 and 572 contain silver and added ingredients other than silver. Preferable examples of the silver alloy films 562 and 572 include the following alloy films: an Ag—Sm—Cu alloy film (which contains silver (Ag), samarium (Sm), and copper (Cu)); an Ag—Bi—Nd alloy film (which contains silver (Ag), bismuth (Bi), and neodymium (Nd)); an Ag—Au alloy film (which contains silver (Ag) and gold (Au)); an Ag—Cu alloy film (which contains silver (Ag) and copper (Cu)); an Ag—Au—Cu alloy film (which contains silver (Ag), gold (Au), and copper (Cu)); an Ag—Si—Cu alloy film (which contains silver (Ag), silicon (Si), and copper (Cu)); an Ag—P—Cu alloy film (which contains silver (Ag), phosphorus (P), and copper (Cu)); an Ag—P—In—Cu alloy film (which contains silver (Ag), phosphorus (P), indium (In), and copper (Cu)); an Ag—Te—Cu alloy film (which contains silver (Ag), tellurium (Te), and copper (Cu)); an Ag—Ga—Cu alloy film (which contains silver (Ag), gallium (Ga), and copper (Cu)); and an Ag—In—Sn alloy film (which contains silver (Ag), indium (In), and tin (Sn)).

These alloy films substantially contain Ag and elements in the respective alloy films (Sm, Cu, Bi, Nd, Au, Si, P, In, Te, Ga, and Sn). However, these alloy films may contain a minute amount of impurity elements (for example, oxygen and nitrogen) in addition to the elements without damaging the operational effect of the invention.

In this way, the fixed mirror 56 and the movable mirror 57 both include the pure silver films 561 and 571 and the silver alloy films 562 and 572, respectively. Accordingly, it is possible to suppress the deterioration in reflectance, which is caused when the fixed mirror 56 and the movable mirror 57 are formed of only the silver alloy films 562 and 572, respectively, thereby approaching the reflectance when they are formed of single layers of the pure silver films 561 and 571.

Since the silver alloy films 562 and 572 more excellent in high-temperature resistance or process resistance than pure silver are stacked on the pure silver films 561 and 571, the surfaces of the pure silver films 561 and 571 are covered with the silver alloy films 562 and 572. Accordingly, the deterioration in reflectance due to processes or time-dependent change decreases, compared with the case where the fixed mirror 56 and the movable mirror 57 include only the pure silver films 561 and 571, respectively.

As a result, it is possible to suppress the deterioration in performance of the interference filter.

In the etalon 5, the balance between the reflectance and the transmittance is important to the fixed mirror 56 and the movable mirror 57. When the thickness of the alloy films of the fixed mirror 56 and the movable mirror 57 is made to increase, high reflectance can be achieved but the transmittance decreases, thereby causing a problem in the detection sensitivity of the interference filter. On the other hand, when the thickness of the alloy films of the fixed mirror 56 and the movable mirror 57 is made to decrease, the transmittance can increase but the reflectance decreases, thereby deteriorating the light-dispersing performance of the interference filter. When the thickness of the silver alloy films 562 and 572 are excessively small, the high-temperature resistance or the process resistance is not satisfactory.

From this point of view, the thickness of the fixed mirror 56 and the movable mirror 57 is preferably in the range of 30 nm to 80 nm and the thickness of the silver alloy films 562 and 572 is preferably equal to or greater than 10 nm.

When the thickness of the fixed mirror 56 and the movable mirror 57 is less than 30 nm, the reflectance of the alloy films is low due to the excessively small thickness and the deterioration in reflectance due to processes or time-dependent change is great. When the thickness of the silver alloy films 562 and 572 is less than 10 nm, the high-temperature resistance or the process resistance is not satisfactory. On the other hand, when the thickness of the fixed mirror 56 and the movable mirror 57 is greater than 80 nm, the transmittance decreases and the functions of the fixed mirror 56 and the movable mirror 57 of the etalon 5 are deteriorated.

The thickness ratio of the pure silver films 561 and 571 and the silver alloy films 562 and 572 is not particularly limited and can be properly changed depending on the necessary characteristics. Accordingly, the thickness of the pure silver films 561 and 571 may be greater than, or may be smaller than, or may be equal to the thickness of the silver alloy films 562 and 572. For example, when it is intended to raise the reflectance, the thickness of the pure silver films 561 and 571 can be set to be greater than the thickness of the silver alloy films 562 and 572. For example, when it is intended to raise the high-temperature resistance or the process resistance, the thickness of the silver alloy films 562 and 572 can be made to increase.

When the silver alloy films 562 and 572 are the Ag—Sm—Cu alloy film, it is preferable that the Sm content is in the range of 0.1 at % to 0.5 at %, the Cu content is in the range of 0.1 at % to 0.5 at %, and the total content of Sm and Cu is equal to or less than 1 at %. When the contents of Sm and Cu are less than 0.1 at %, the deterioration in reflectance due to processes or time-dependent change increases. When the contents of Sm and Cu are greater than 0.5 at %, the reflectance decreases. When the sum of the contents of Sm and Cu exceeds at %, the reflectance decreases. The balance is substantially Ag, but a minute amount of impurities may be contained therein without damaging the operational effect of the invention.

When the silver alloy films 562 and 572 are the Ag—Bi—Nd alloy film, it is preferable that the Bi content is in the range of 0.1 at % to 3 at % and the Nd content is in the range of 0.1 at % to 5 at %. It is more preferable that the Bi content is in the range of 0.1 at % to 2 at %, the Nd content is in the range of 0.1 at % to 3 at %. When the contents of Bi and Nd are less than 0.1 at %, the deterioration in reflectance due to processes or time-dependent change increases. When the Bi content is greater than 3 at % or the Nd content is greater than 5 at %, the reflectance decreases. The balance is substantially Ag, but a minute amount of impurities may be contained therein without damaging the operational effect of the invention.

The compositions of the alloy films when the silver alloy films 562 and 572 are one of the Ag—Au alloy film, the Ag—Cu alloy film, the Ag—Au—Cu alloy film, the Ag—Si—Cu alloy film, the Ag—P—Cu alloy film, the Ag—P—In—Cu alloy film, the Ag—Te—Cu alloy film, the Ag—Ga—Cu alloy film, and the Ag—In—Sn alloy film are preferably in the following ranges.

Ag—Au alloy film in which the Au content is in the range of 0.1 at % to 10 at %

Ag—Cu alloy film in which the Cu content is in the range of 0.1 at % to 10 at %

Ag—Au—Cu alloy film in which the Au content is equal to or greater than 0.1 at %, the Cu content is equal to or greater than 0.1 at %, and the total content of Au and Cu is equal to or less than 10 at %

Ag—Si—Cu alloy film in which the Si content is equal to or greater than 0.1 at %, the Cu content is equal to or greater than 0.1 at %, and the total content of Si and Cu is equal to or less than 10 at %

Ag—P—Cu alloy film in which the P content is equal to or greater than 0.1 at %, the Cu content is equal to or greater than 0.1 at %, and the total content of P and Cu is equal to or less than 10 at %

Ag—P—In—Cu alloy film in which the P content is equal to or greater than 0.1 at %, the In content is equal to or greater than 0.1 at %, the Cu content is equal to or greater than 0.1 at %, and the total content of P, In, and Cu is equal to or less than 10 at %

Ag—Te—Cu alloy film in which the Te content is equal to or greater than 0.1 at %, the Cu content is equal to or greater than 0.1 at %, and the total content of Te and Cu is equal to or less than 10 at %

Ag—Ga—Cu alloy film, the Ga content is equal to or greater than 0.1 at %, the Cu content is equal to or greater than 0.1 at %, and the total content of Ga and Cu is equal to or less than 10 at %

Ag—In—Sn alloy film, the In content is equal to or greater than 0.1 at %, the Sn content is equal to or greater than 0.1 at %, and the total content of In and Sn is equal to or less than 10 at %

When the silver alloy films 562 and 572 are one of the Ag—Au alloy film, the Ag—Cu alloy film, the Ag—Au—Cu alloy film, the Ag—Si—Cu alloy film, the Ag—P—Cu alloy film, the Ag—P—In—Cu alloy film, the Ag—Te—Cu alloy film, the Ag—Ga—Cu alloy film, and the Ag—In—Sn alloy film and the contents of the elements (Au, Cu, Si, P, In, Te, Ga, and Sn) are less than 0.1 at %, the deterioration in reflectance due to processes or time-dependent change increases. When the total content of the elements contained in the alloy film is greater than 10 at %, the reflectance decreases. In the alloy films, the balance other than the elements is substantially Ag but a minute amount of impurities may be contained therein without damaging the operational effect of the invention.

The fixed mirror 56 and the movable mirror 57 are formed by a known method such as a sputtering method using target materials having the compositions of the alloy films.

Regarding the fixed mirror 56, the pure silver film 561 and the silver alloy film 562 are stacked sequentially from the first substrate 51. Regarding the movable mirror 57, the pure silver film 571 and the silver alloy film 572 are stacked sequentially from the second substrate 52. Accordingly, in forming the fixed mirror 56 and the movable mirror 57, the formation of silver alloy films 562 and 572 can be performed subsequently to the formation of the pure silver films 561 and 571. That is, the continuous film formation of forming the silver alloy films 562 and 572 without exposing them to the atmosphere after forming the pure silver films 561 and 571 can be performed. In this way, since exposure of the pure silver films 561 and 571 to the atmosphere is prevented, it is possible to suppress the deterioration in reflectance of the fixed mirror 56 and the movable mirror 57.

### 3-1-2. Configuration of Pair of Substrates

The first substrate 51 and the second substrate 52 as a pair of substrates are formed of a variety of glass such as soda glass, crystalline glass, quartz glass, lead glass, potassium glass, non-alkali glass, and borosilicate glass or crystal. Among these, glass containing alkali metal such as sodium (Na) or potassium (K) can be preferably used as the material of the pair of substrates. By forming the first substrate 51 and the second substrate 52 out of this glass, it is possible to enhance the close adhesiveness of the fixed mirror 56 and the movable mirror 57 as a pair of reflective films to be described later or the electrodes or the bonding strength between the substrates. Glass has an excellent characteristic of transmitting a visible ray. Accordingly, as this embodiment, when the color of the test object A is measured, the absorption of light in the first substrate 51 and the second substrate 52 can be suppressed and thus glass is appropriately used for a colorimetric process. The first substrate 51 and the second substrate 52 are formed in a body by bonding the bonding faces 514 and 524 formed along the outer circumferential edge by the use of a bonding film 53. An example of the bonding film 53 is a plasma polymerized film.

The first substrate 51 is formed by processing a glass substrate with a thickness of, for example, 500 μm by etching. Specifically, as shown in FIG. 3, an electrode-forming groove 511 and a mirror fixing portion 512 are formed in the first substrate 51 by etching.

The electrode-forming groove 511 is formed in a circular shape centered on a planar center point in a plan view when the etalon 5 is seen in the thickness direction (hereinafter, referred to as an etalon plan view). The mirror fixing portion 512 is formed to protrude from the center of the electrode-forming groove 511 toward the second substrate 52, as shown in FIG. 3.

In the electrode-forming groove 511, a ring-like electrode fixing face 511A is formed from the outer circumferential edge of the mirror fixing portion 512 to the inner circumferential wall of the electrode-forming groove 511, and the first displacement electrode 541 is formed on the electrode fixing face 511A. The first displacement electrode 541 is connected to the voltage controller 6 via a fixed electrode extracting line 541A and an external line not shown. The fixed electrode extracting line 541A is connected to the external line via a fixed electrode extracting portion 541B formed between the bonding face 514 and the bonding face 524.

The mirror fixing portion 512 is formed in a circumferential shape with a diameter smaller than that of the electrode-forming groove 511 to be coaxial with the electrode-forming groove 511, as described above. In this embodiment, as shown in FIG. 3, the mirror fixing face 512A of the mirror fixing portion 512 facing the second substrate is formed closer to the second substrate 52 than the electrode fixing face 511A.

In the first substrate 51, an antireflection film (AR) not shown is formed at a position corresponding to the fixed mirror 56 on the bottom surface opposite to the top surface facing the second substrate 52. The antireflection film is formed by alternately stacking a low-refractive film and a high-refractive index film, lowers the reflectance of a visible ray by the surface of the first substrate 51, and raises the transmittance.

The second substrate 52 is formed by processing a glass substrate with a thickness of, for example, 200 μm by etching.

Specifically, the second substrate 52 is provided with a circular movable portion 521 centered on a substrate center point and a connection holding portion 522 being coaxial with the movable portion 521 and holding the movable portion 521 in a plane view shown in FIG. 2. The outer diameter of the connection holding portion 522 is equal to the outer diameter of the electrode-forming groove 511 of the first substrate 51.

The movable portion 521 has a thickness greater than that of the connection holding portion 522 and has a thickness of, for example, 200 μm which is equal to the thickness of the second substrate 52 in this embodiment.

An antireflection film (AR) not shown is formed on the top surface of the movable portion 521 opposite to the first substrate 51. This antireflection film has the same configuration as the antireflection film formed on the first substrate 51 and is formed by alternately stacking a low-refractive film and a high-refractive film.

The connection holding portion 522 is a diaphragm surrounding the movable portion 521 and has a thickness of, for example, 50 μm. The second displacement electrode 542 having a ring shape is formed on the surface of the connection holding portion 522 facing the first substrate 51. The second displacement electrode 542 faces the first displacement electrode 541 with an electromagnetic gap of about 1 μm interposed therebetween.

The second displacement electrode 542 is connected to the voltage controller 6 via a movable electrode extracting line 542A and an external line not shown. The movable electrode extracting line 542A is connected to the external line via a movable electrode extracting portion 542B formed between the bonding face 514 and the bonding face 524.

The electrostatic actuator 54 is constructed by the second displacement electrode 542 and the first displacement electrode 541.

In the etalon 5, an electrostatic attractive force is generated between the first displacement electrode 541 and the second displacement electrode 542 by applying a predetermined voltage to the electrostatic actuator 54. By this electrostatic attractive force, the movable portion 521 moves in the substrate thickness direction, whereby the second substrate 52 is deformed and the magnitude of inter-mirror gap G is changed. By adjusting the applied voltage in this way and controlling the electrostatic attractive force generated between the first displacement electrode 541 and the second displacement electrode 542, the change of the magnitude of inter-mirror gap G is controlled, thereby enabling the selection of light to be dispersed from the test object light.

### 4. Configuration of Control Unit

Referring to FIG. 1 again, the configuration of the control unit 4 will be described below.

The control unit 4 controls the entire operation of the colorimetric device 1.

For example, a general-purpose personal computer, a personal digital assistant (PDA), and other colorimetry-dedicated computers can be used as the control unit 4.

As shown in FIG. 1, the control unit 4 includes a light source controller 41, a colorimetric sensor controller 42, and a calorimetric processing unit 43 (the processing unit described in the claims).

The light source controller 41 is connected to the light source unit 2. The light source controller 41 outputs a predetermined control signal to the light source unit 2 on the basis of, for example, a user's setting input so as to emit white light with predetermined brightness from the light source unit 2.

The colorimetric sensor controller 42 is connected to the colorimetric sensor 3. The colorimetric sensor controller 42 sets the wavelength of light to be received by the colorimetric sensor 3, for example, on the basis of a user's setting input and outputs a control signal instructing to detect the light intensity of light of the set wavelength to the colorimetric sensor 3. Accordingly, the voltage controller 6 of the colorimetric sensor 3 sets a voltage to be applied to the electrostatic actuator 54 so as to transmit only light of the wavelength desired by the user on the basis of the control signal.

The colorimetric processing unit 43 controls the colorimetric sensor controller 42 to change the inter-reflective-film gap of the etalon 5 and to change the wavelength of light to be transmitted by the etalon 5. The colorimetric processing unit 43 acquires the light intensity of light transmitted by the etalon 5 on the basis of the light-reception signal input from the detection unit 31. The colorimetric processing unit 43 calculates the chromaticity of light reflected by the test object A on the basis of the light intensity of light of the wavelengths acquired as described above.

### 5. Method of Manufacturing Etalon

The mirror fixing portion 512 and the like of the first substrate 51 and the movable portion 521 and the like of the second substrate 52 are formed by performing an etching process on a glass substrate as a manufacturing material.

The pure silver film 561 is formed on the first substrate 51 having been subjected to the etching process and the silver alloy film 562 is formed on the pure silver film 561 by the use of a sputtering method without exposing the pure silver film to the atmosphere. Similarly, the pure silver film 571 is formed on the second substrate 52 having been subjected to the etching process and the silver alloy film 572 is formed thereon by the use of a sputtering method without exposing the pure silver film 571 to the atmosphere. In this way, the fixed mirror 56 and the movable mirror 57 are formed.

In a patterning process of patterning the fixed mirror 56 and the movable mirror 57 having been subjected to the sputtering film formation in a desired shape, a wet etching method is used. In the wet etching method, the following processes are performed, for example.

(A) A resist film as an etching mask is formed in a desired pattern on the silver alloy films 562 and 572. The alloy films are exposed to a high temperature at the time of curing the resist film. However, since the pure silver films 561 and 571 are covered with the silver alloy films 562 and 572, the pure silver films are not exposed to the high-temperature gas.

(B) The resist film is removed by the use of an organic resist-peeling solution. At this time, the silver alloy films 562 and 572 are exposed to the organic solvent. However, since the pure silver films 561 and 571 are covered with the silver alloy films 562 and 572, the pure silver films are not exposed to the organic solvent.

Since the silver alloy films 562 and 572 are under these situations, the silver alloy films 562 and 572 require high-temperature resistance or organic solvent resistance. In addition, a variety of resistance such as high-temperature and high-humidity resistance, sulfide resistance, and halogen resistance is required for the silver alloy films 562 and 572. Hereinafter, all the resistance required for the silver alloy films 562 and 572 in the process of manufacturing an etalon is also referred to as process resistance and, particularly, the resistance required for the alloy films in the patterning process is referred to as patterning process resistance.

Through the wet etching process, the fixed mirror 56 and the movable mirror 57 are formed on the first substrate 51 and the second substrate 52, respectively.

Thereafter, the first substrate 51 and the second substrate 52 are bonded to each other to acquire the etalon 5. In the bonding process, for example, a plasma polymerized film is formed on the bonding faces 514 and 524, the plasma polymerized films are bonded to each other, whereby the first substrate 51 and the second substrate 52 are bonded to each other.

### 6. Operational Effect of First Embodiment

In the etalon 5, since the fixed mirror 56 and the movable mirror 57 include the pure silver films 561 and 571 and the silver alloy films 562 and 572, it is possible to raise the reflectance, compared with the case where the fixed mirror and the movable mirror include only a silver alloy film. In addition, since the silver alloy films 562 and 572 which are more excellent in high-temperature resistance or process resistance than pure silver are stacked on the pure silver films 561 and 571, the surfaces of the pure silver films 561 and 571 are covered with the silver alloy films 562 and 572. Accordingly, compared with the case where the fixed mirror and the movable mirror include only the pure silver film, it is possible to suppress the deterioration in reflectance due to processes or time-dependent change, thereby suppressing the deterioration in performance of the etalon 5.

The thicknesses of the fixed mirror 56 and the movable mirror 57 of the etalon 5 are in the range of 30 nm to 80 nm. The thicknesses of the silver alloy films 562 and 572 are equal to or greater than 10 nm. Accordingly, since the thicknesses of the fixed mirror 56 and the movable mirror are not excessively great, the deterioration in transmittance is suppressed, thereby suppressing the deterioration in performance of the interference filter. Since the high-temperature resistance or the process resistance is given to the fixed mirror 56 and the movable mirror 57 by the silver alloy films 562 and 572, it is possible to suppress the change in reflectance and transmittance due to processes or time-dependent change. As a result, it is possible to suppress the deterioration in the two characteristics of reflection and transmission of light, which are required for the reflective films of the etalon 5.

Since the compositions of the silver alloy films 562 and 572 of the etalon 5 are in the above-mentioned ranges, it is possible to further suppress the deterioration in reflectance due to processes or time-dependent change, thereby satisfactorily suppressing the deterioration in performance of the etalon 5.

### Second Embodiment

A second embodiment of the invention will be described below.

In the second embodiment, the same elements as in the first embodiment are referenced by the same reference numerals and signs and the description thereof is not repeated or is made in brief.

An etalon 5A according to the second embodiment is different from the etalon 5 according to the first embodiment, in that the fixed mirror 56 and the movable mirror 57 of the etalon 5A include dielectric films 563 and 573, the pure silver films 561 and 571, and the silver alloy films 562 and 572. The silver alloy films 562 and 572 are one of the Ag—Sm—Cu alloy film, the Ag—Bi—Nd alloy film, the Ag—Au alloy film, the Ag—Cu alloy film, the Ag—Au—Cu alloy film, the Ag—Si—Cu alloy film, the Ag—P—Cu alloy film, the Ag—P—In—Cu alloy film, the Ag—Te—Cu alloy film, the Ag—Ga—Cu alloy film, and the Ag—In—Sn alloy film described in the first embodiment.

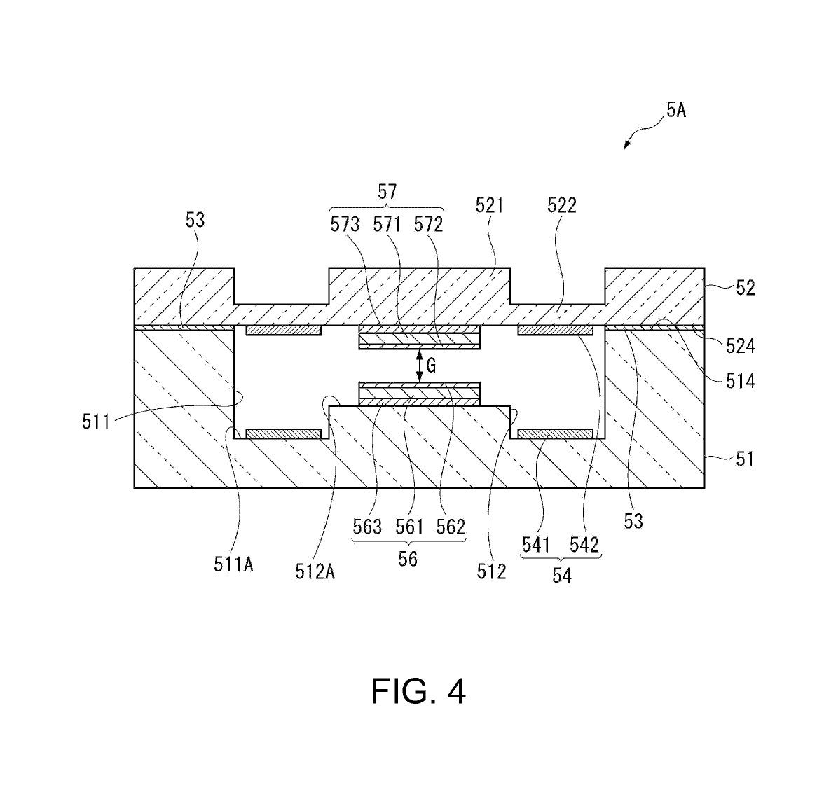

As shown in FIG. 4, the dielectric film 563, the pure silver film 561, and the silver alloy film 562 are formed on the first substrate sequentially from the first substrate 51. That is, the dielectric film 563 is disposed between the first substrate 51 and the pure silver film 561. Similarly, the dielectric film 573, the pure silver film 571, and the silver alloy film 572 are formed on the second substrate 52 sequentially from the second substrate 52. That is, the dielectric film 573 is disposed between the second substrate 52 and the pure silver film 571.

The dielectric films 563 and 573 are one of a single-layered film of titanium oxide (TiO₂) and a multi-layered film in which a layer of titanium oxide (TiO₂) or tantalum pentoxide (Ta₂O₅) and a layer of silicon oxide (SiO₂) or magnesium fluoride (MgF₂) are stacked. In the latter dielectric multi-layered film, a layer of a high-refractive material (TiO₂, Ta₂O₅) and a layer of a low-refractive material (SiO₂, MgF₂) are stacked. The thicknesses or the number of layers of the single-layered film or the layers of the multi-layered film are appropriately set on the basis of the necessary optical characteristics.

### Operational Effect of Second Embodiment

In the etalon 5A according to the second embodiment, since the fixed mirror 56 and the movable mirror 57 have the structure in which the dielectric films 563 and 573, the pure silver films 561 and 571, and the silver alloy films 562 and 572 are stacked, it is possible to further enhance the reflectance on a short wavelength side in the visible ray range, compared with the case where they include only the pure silver films 561 and 571 and the silver alloy films 562 and 572 as in the first embodiment. As a result, it is possible to widen the wavelength range in which higher reflectance is exhibited, thereby obtaining the etalon 5A including the fixed mirror 56 and the movable mirror 57 having high reflectance over the visible ray range.

Since the dielectric films 563 and 573 are excellent in close adhesiveness to the pure silver films 561 and 571 and are more excellent in close adhesiveness to the glass substrate, it is possible to suppress the deterioration in performance of the etalon 5A due to the poor adhesive force.

### Third Embodiment

A third embodiment of the invention will be described below.

In the third embodiment, the same elements as in the first and second embodiments are referenced by the same reference numerals and signs and the description thereof is not repeated or is made briefly.

An etalon 5B according to the third embodiment is different from the etalon 5 according to the first embodiment and the etalon 5A according to the second embodiment, in that the fixed mirror 56 and the movable mirror 57 of the etalon 5B include protective films 564 and 574 in addition to the dielectric films 563 and 573, the pure silver films 561 and 571, and the silver alloy films 562 and 572. The silver alloy films 562 and 572 are one of the Ag—Sm—Cu alloy film, the Ag—Bi—Nd alloy film, the Ag—Au alloy film, the Ag—Cu alloy film, the Ag—Au—Cu alloy film, the Ag—Si—Cu alloy film, the Ag—P—Cu alloy film, the Ag—P—In—Cu alloy film, the Ag—Te—Cu alloy film, the Ag—Ga—Cu alloy film, and the Ag—In—Sn alloy film described in the first embodiment. The dielectric films 563 and 573 are the same as described in the second embodiment.

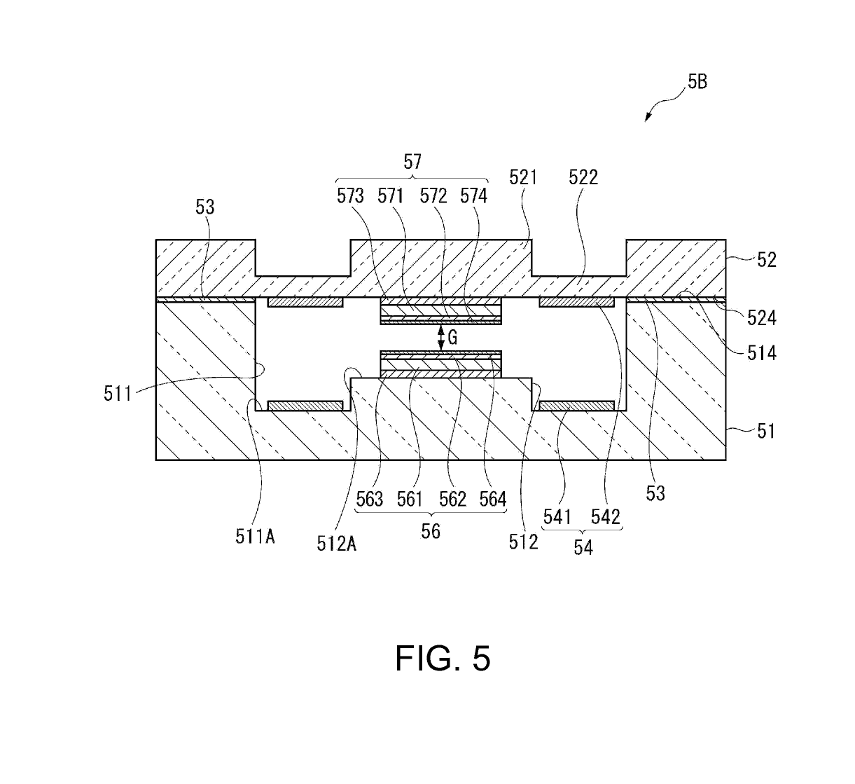

As shown in FIG. 5, the dielectric film 563, the pure silver film 561, the silver alloy film 562, and the protective film 564 are formed on the first substrate sequentially from the first substrate 51. That is, the protective film 564 is disposed on the side of the silver alloy film 562 opposite to the pure silver film 561. Similarly, the dielectric film 573, the pure silver film 571, the silver alloy film 572, and the protective film 574 are formed on the second substrate 52 sequentially from the second substrate 52. The protective film 574 is disposed on the side of the silver alloy film 572 opposite to the pure silver film 571.

The protective films 564 and 574 contain silicon oxide (SiO2), silicon oxynitride (SiON), silicon nitride (SiN), ITO, or alumina. The thicknesses of the protective films 564 and 574 are preferably in the range of 10 nm to 20 nm. By setting the thicknesses to such a range, it is possible to protect the fixed mirror 56 and the movable mirror 57 without deteriorating the reflectance and the transmittance.

When the thicknesses of the protective films 564 and 574 are made to further increase, it is possible to improve the resistance of the pure silver films 561 and 571, but it causes the deterioration in reflectance and transmittance. Accordingly, even when the protective films 564 and 574 are formed, it is preferable that the pure silver films 561 and 571 and the silver alloy films 562 and 572 are stacked without setting the protective films to an excessive thickness so as to give the resistance without deteriorating the reflectance and the transmittance.

### Operational Effect of Third Embodiment

In the etalon 5B according to the third embodiment, since the dielectric films 563 and 573, the pure silver films 561 and 571, and the silver alloy films 562 and 572 are protected with the protective films 564 and 574, the deterioration in reflectance of the pure silver films 561 and 571 and the silver alloy films 562 and 572 due to processes or time-dependent change is suppressed, thereby more satisfactorily preventing the deterioration in performance of the interference filter.

### Other Embodiments

The invention is not limited to the above-mentioned embodiments, but modifications, improvements, and the like thereof allowing the achievement of the advantages of the invention are included in the invention.

The etalons having a square shape in a plan view have been described in the above-mentioned embodiments, but the invention is not limited to the shape. For example, the etalon may have a planar circular shape or a planar diagonal shape.

The fixed mirror 56 and the movable mirror 57 may not be formed of the same silver alloy film. For example, the silver alloy film 562 of the fixed mirror 56 may be the Ag—Sm—Cu alloy film and the silver alloy film 572 of the movable mirror 57 may be the Ag—Bi—Nd alloy film.

It has been stated in the embodiments that the etalon 5 is the wavelength-variable interference filter, but the invention is not limited to this example. A pair of mirrors formed of the alloy films can be applied to an interference filter in which the magnitude of the inter-mirror gap is not changed.

The heights of the electrode fixing face 511A and the mirror fixing face 512A are properly set on the basis of the magnitude of inter-mirror gap G between the fixed mirror 56 fixed to the mirror fixing face 512A and the movable mirror 57 formed on the second substrate 52, the distance between the first displacement electrode 541 and the second displacement electrode 542, and the thickness of the fixed mirror 56 or the movable mirror 57, and is not limited to the configuration described in the above-mentioned embodiments. For example, when the fixed mirror 56 and the movable mirror 57 include a dielectric multi-layered film and the thicknesses thereof increase, the configuration in which the electrode fixing face 511A and the mirror fixing face 512A are formed to be flush with each other or the configuration in which a mirror-fixing groove having a circumferential groove shape is formed at the center of the electrode fixing face 511A and the mirror fixing face 512A is formed on the bottom surface of the mirror-fixing groove may be employed.

Although it has been stated in the embodiments that one extraction electrode is disposed in the first displacement electrode 541, the invention is not limited to this configuration. The number of extraction electrodes may increase. In this case, among two extraction electrodes, one may be used as a voltage application terminal used to apply a voltage to the first displacement electrode 541 and the other may be used as a charge detecting terminal used to detect charges held by the first displacement electrode 541. The same is true of the second displacement electrode 542.

Although it has been stated in the embodiments that the etalon 5 can adjust the inter-mirror gap G by the use of the electrostatic actuator 54, the inter-mirror gap G may be adjusted by the use of other driving members. For example, an electrostatic actuator or a piezoelectric member pressing the second substrate 52 to the side of the second substrate 52 opposite to the first substrate 51 by the use of a repulsive force may be provided.

The invention is not limited to the configuration in which the dielectric film, the pure silver film, the silver alloy film, and the protective film are stacked on the substrate as described in the third embodiment, but the pure silver film, the silver alloy film, and the protective film may be stacked on the substrate without disposing the dielectric film.

In addition, the structure and order for putting the invention into practice can be properly changed to another structure or the like allowing the achievement of the advantages of the invention.

### Examples

The high-temperature resistance or the process resistance of the alloy film in the invention will be described in more detail, but the invention is not limited to this description.

### 1. High Temperature Resistance

1-1.

First, the high-temperature resistance of the pure silver film and the silver alloy film are evaluated. Examples (Examples 1 and 2) in which the pure silver film and the silver alloy film are stacked, a comparative example (Comparative Example 1) in which a single-layered pure silver film is employed, and comparative examples (Comparative Examples 2 to 4) in which a single-layered silver alloy film is employed are compared with each other.

The pure silver film and the silver alloy film are formed on a smooth glass substrate by the use of a sputtering method using a target material of the pure silver film and a target material of the silver alloy film having the following alloy compositions.

Ag—C in which the C content is 5.0 at % and the balance is substantially Ag

Ag—Sm—Cu in which the Sm content is 0.5 at %, the Cu content is 0.5 at %, and the balance is substantially Ag

Ag—Bi—Nd in which the Bi content is 1.0 at %, the Nd content is 0.5 at %, and the balance is substantially Ag

The thickness of the single-layered film is set to 40 nm. In the case of the stacked layers, the thickness of the pure silver film is set to 30 nm and the thickness of the silver alloy film is set to 10 nm.

Regarding the high-temperature resistance, the initial reflectance after the pure silver film, the silver alloy film, and the stacked film are formed and the reflectance after the films are heated at 250° C. for 1 hour under the atmospheric environment (after the high-temperature test) are compared with each other. The reflectance in the visible ray wavelength range of 400 nm to 700 nm is measured using a spectral colorimeter.

The initial reflectance (unit: %) and the reflectance after the heat treatment (unit: %) of the pure silver film, the silver alloy film, and the stacked film at the wavelengths of 400 nm, 550 nm, and 700 nm are shown in Table 1. In Table 1, the value obtained by subtracting the reflectance after the high-temperature test from the initial reflectance is shown as a variation (decrease) in reflectance (unit: %). In the film structures described in the table, for example, (pure silver)/(Ag—Sm—Cu) represents that the pure silver film and the Ag—Sm—Cu alloy film are stacked. The same is true of the other tables.

TABLE 1

| | | Wavelength | | | | | | | | |
|---|---|---|---|---|---|---|---|---|---|---|
| | | 400 nm | | | 550 nm | | | 700 nm | | |
| | | Initial | Reflectance | | Initial | Reflectance | | | Reflectance | |
| | | Reflect- | after High- | Variation in | Reflect- | after High- | Variation in | Initial | after High- | Variation in |
| | | ance | temperature | Reflectance | ance | temperature | Reflectance | Reflectance | temperature | Reflectance |
| | Film Structure | [%] | Test [%] | [%] | [%] | Test [%] | [%] | [%] | Test [%] | [%] |
| Example 1 | (Pure Silver)/ | 73.4 | 72.3 | 1.1 | 90.2 | 89.5 | 0.7 | 94.9 | 94.7 | 0.2 |
| | (Ag—Sm—Cu) | | | | | | | | | |
| Example 2 | (Pure Silver)/ | 73.4 | 72.7 | 0.7 | 90.2 | 89.7 | 0.5 | 95.0 | 94.8 | 0.2 |
| | Ag—Bi—Nd | | | | | | | | | |
| Comparative | Pure Silver | 74.1 | 48.2 | 25.9 | 90.1 | 78.5 | 11.6 | 95.0 | 86.6 | 8.4 |
| Example 1 | | | | | | | | | | |
| Comparative | Ag—C | 65.5 | 61.4 | 4.1 | 85.1 | 82.3 | 2.8 | 91.8 | 90.1 | 1.7 |
| Example 2 | | | | | | | | | | |
| Comparative | Ag—Sm—Cu | 71.4 | 70.3 | 1.1 | 90.4 | 89.7 | 0.7 | 94.6 | 94.4 | 0.2 |
| Example 3 | | | | | | | | | | |
| Comparative | Ag—Bi—Nd | 71.1 | 70.5 | 0.6 | 90.4 | 89.9 | 0.5 | 94.8 | 94.7 | 0.1 |
| Example 4 | | | | | | | | | | |

As can be seen from Table 1, the pure silver film in Comparative Example 1 has the highest initial reflectance but the reflectance is markedly lowered by the high-temperature test. This is because the grain aggregate of the pure silver film exposed to a high temperature grows to increase the surface roughness and thus to greatly lower the reflectance.

Among the single-layered silver alloy films, the Ag—C alloy film in Comparative Example 2 has the initial reflectance much lower than that of the pure silver film. The Ag—Sm—Cu alloy film in Comparative Example 3 and the Ag—Bi—Nd alloy film in Comparative example 4 exhibit the reflectance closer to that of the pure silver film than that of the Ag—C alloy film, but the initial reflectance at 400 nm is low. The Ag—Sm—Cu alloy film in Comparative Example 3 and the Ag—Bi—Nd alloy film in Comparative Example 4 exhibit the reflectance higher than that of the pure silver film and the Ag—C alloy film after the high-temperature test.

On the other hand, in Example 1 in which the pure silver film and the Ag—Sm—Cu alloy film are stacked and Example 2 in which the pure silver film and the Ag—Bi—Nd alloy film are stacked, the characteristics thereof are more excellent than those of Comparative Examples 1 to 4. That is, the initial reflectance of the stacked films in Example 1 and Example 2 is higher than those of the single-layered silver alloy film in Comparative Example 3 or Comparative Example 4 and is close to that of the pure silver film in Comparative Example 1. It can be seen that the stacked films in Example 1 and Example 2 have high reflectance after the high-temperature test and have a small variation relative to the initial reflectance. The reflectance of the stacked films in Example 1 and Example 2 after the high-temperature test is higher in any wavelength than that of the pure silver film and is particularly higher in a short wavelength side (400 nm) than that of the single-layered alloy film.

As a result, it can be seen that the initial reflectance and the reflectance after the high-temperature test are higher by employing the stacked film of the pure silver film and the silver alloy film as in Example 1 and Example 2. This is because the high reflectance can be achieved due to the pure silver film and the deterioration in reflectance after the high-temperature test is suppressed by stacking the silver alloy film excellent in high-temperature resistance on the pure silver film. By setting the thickness of the pure silver film to three times the thickness of the silver alloy film, it is thought that the high reflectance is achieved.

1-2.

The high-temperature resistance of the following silver alloy films in addition to the silver alloy films used in Examples 1 and 2 is evaluated.

Ag—Au in which the Au content is 1.0 at % and the balance is substantially Ag

Ag—Cu in which the Cu content is 1.0 at % and the balance is substantially Ag

Ag—Au—Cu in which the Au content is 1.0 at %, the Cu content is 1.0 at %, and the balance is substantially Ag

Ag—Si—Cu in which the Si content is 1.0 at %, the Cu content is 1.0 at %, and the balance is substantially Ag

Ag—P—Cu in which the P content is 1.0 at %, the Cu content is 1.0 at %, and the balance is substantially Ag

Ag—P—In—Cu in which the P content is 0.5 at %, the In content is 0.5 at %, the Cu content is 1.0 at %, and the balance is substantially Ag

Ag—Te—Cu in which the Te content is 1.0 at %, the Cu content is 1.0 at %, and the balance is substantially Ag

Ag—Ga—Cu in which the Ga content is 1.0 at %, the Cu content is 1.0 at %, and the balance is substantially Ag

Ag—In—Sn in which the In content is 1.0 at %, the Sn content is 1.0 at %, and the balance is substantially Ag

These single-layered silver alloy films are formed on a glass substrate as described above and the high-temperature resistance is measured. The measurement results are shown as reference examples in Table 2.

TABLE 2

| | | Wavelength | | | | | | | | |
|---|---|---|---|---|---|---|---|---|---|---|
| | | 400 nm | | | 550 nm | | | 700 nm | | |
| | | Initial | Reflectance | | Initial | Reflectance | | | Reflectance | |
| | | Reflect- | after High- | Variation in | Reflect- | after High- | Variation in | Initial | after High- | Variation in |
| | | ance | temperature | Reflectance | ance | temperature | Reflectance | Reflectance | temperature | Reflectance |
| | Film Structure | [%] | Test [%] | [%] | [%] | Test [%] | [%] | [%] | Test [%] | [%] |
| Reference | Ag—Au | 64.4 | 57.9 | 6.5 | 86.4 | 83.3 | 3.1 | 92.7 | 90.5 | 2.2 |
| Example 1 | | | | | | | | | | |
| Reference | Ag—Cu | 66.2 | 61.2 | 5.0 | 88.1 | 84.6 | 3.5 | 92.9 | 90.9 | 2.0 |
| Example 2 | | | | | | | | | | |
| Reference | Ag—Au—Cu | 63.0 | 57.3 | 5.7 | 85.3 | 82.1 | 3.2 | 92.4 | 89.9 | 2.5 |
| Example 3 | | | | | | | | | | |
| Reference | Ag—Si—Cu | 70.1 | 67.1 | 3.0 | 89.7 | 88.2 | 1.5 | 93.8 | 930. | 0.8 |
| Example 4 | | | | | | | | | | |
| Reference | Ag—P—Cu | 63.9 | 60.2 | 3.7 | 86.2 | 84.3 | 1.9 | 91.8 | 90.9 | 0.9 |
| Example 5 | | | | | | | | | | |
| Reference | Ag—P—In—Cu | 61.4 | 58.9 | 2.5 | 84.5 | 82.7 | 1.8 | 90.8 | 89.9 | 0.9 |
| Example 6 | | | | | | | | | | |
| Reference | Ag—Te—Cu | 60.1 | 59.0 | 1.1 | 79.5 | 78.7 | 0.8 | 86.1 | 85.6 | 0.5 |
| Example 7 | | | | | | | | | | |
| Reference | Ag—Ga—Cu | 56.7 | 50.7 | 6.0 | 80.7 | 76.6 | 4.1 | 88.5 | 85.5 | 3.0 |
| Example 8 | | | | | | | | | | |
| Reference | Ag—In—Sn | 66.5 | 61.4 | 5.1 | 87.4 | 84.5 | 2.9 | 92.2 | 90.7 | 1.5 |
| Example 9 | | | | | | | | | | |

As can be seen from Table 2, the variations in reflectance of the Ag—Au alloy film, the Ag—Cu alloy film, the Ag—Au—Cu alloy film, the Ag—Si—Cu alloy film, the Ag—P—Cu alloy film, the Ag—P—In—Cu alloy film, the Ag—Te—Cu alloy film, the Ag—Ga—Cu alloy film, and the Ag—In—Sn alloy film (hereinafter, referred to as silver alloy films according to the reference examples) are smaller than that of the single-layered pure silver film in Comparative Example 1. Accordingly, by stacking the silver alloy films according to the reference examples on the pure silver film, it is guessed that it is possible to suppress the deterioration in reflectance after the high-temperature test. Among these, the alloy film according to Reference Example 4 is higher in reflectance after the high-temperature test in any wavelength than the Ag—C alloy film in Comparative Example 2 and exhibits the reflectance equivalent to those of the silver alloy films in Comparative Example 3 and Comparative Example 4. As a result, it is guessed that it is possible to achieve the same advantages of suppressing the deterioration in reflectance after the high-temperature test as described in Example 1 or Example 2 by stacking the silver alloy film according to Reference Example 4 on the pure silver film.

### 2. Process Resistance

2-1.

The process resistance of the pure silver film and the silver alloy film is evaluated. Examples (Examples 3 and 4) where the pure silver film and the silver alloy film are stacked, a comparative example (Comparative Example 5) where the single-layered pure silver film is employed, and comparative examples (Comparative Examples 6 to 8) where the single-layered silver alloy film is employed are compared with each other. The film structures are shown in Table 3.

Similarly to the evaluation of the high-temperature resistance, the pure silver film and the silver alloy film are formed on a smooth glass substrate by the use of a sputtering method using target materials having compositions of the pure silver film and the silver alloy film.

The patterning process resistance is evaluated as the process resistance. The patterning process is performed as follows.

(1) A positive resist is applied to the pure silver film, the silver alloy film, and the stacked film formed on the glass substrate by the use of a spin coater.

(2) The resultant structure is pre-baked in a clean oven at 90° C. for 15 minutes after the application of the positive resist.

(3) The resultant structure is exposed with a photo mask by the use of a contact aligner.

(4) The resultant structure is developed using a tetramethyl ammonium hydroxide solution as a developer.

(5) The resultant structure is post-baked in a clean oven at 120° C. for 20 minutes.

(6) The pure silver film, the silver alloy film, and the stacked film are etched with a phosphoric-acetic-nitric acid solution using the resist as an etching mask.

(7) The resist is removed with an organic resist peeling solution.

Similarly to the evaluation of the high-temperature resistance, the initial reflectance of the pure silver film, the silver alloy film, and the stacked film and the reflectance after the patterning process thereof are compared.

The initial reflectance (unit: %) and the reflectance after the patterning process (unit: %) of the pure silver film and the silver alloy film at the wavelengths of 400 nm, 550 nm, and 700 nm are shown in Table 3. In Table 3, the value obtained by subtracting the reflectance after the patterning process from the initial reflectance is shown as a variation (decrease) in reflectance (unit: %).

TABLE 3

| | | Wavelength | | | | | | | | |
|---|---|---|---|---|---|---|---|---|---|---|
| | | 400 nm | | | 550 nm | | | 700 nm | | |
| | | Initial | Reflectance | | | Reflectance | | Initial | Reflectance | |
| | | Reflect- | after | Variation in | Initial | after | Variation in | Reflect- | after | Variation in |
| | | ance | Patterning | Reflectance | Reflectance | Patterning | Reflectance | ance | Patterning | Reflectance |
| | Film Structure | [%] | process [%] | [%] | [%] | process [%] | [%] | [%] | process [%] | [%] |
| Example 3 | (Pure Silver)/ | 73.4 | 71.9 | 1.5 | 90.2 | 90.0 | 0.2 | 94.9 | 94.9 | 0.0 |
| | (Ag—Sm—Cu) | | | | | | | | | |
| Example 4 | (Pure Silver)/ | 73.4 | 70.5 | 2.9 | 90.2 | 89.7 | 0.5 | 95.0 | 94.8 | 0.2 |
| | Ag—Bi—Nd | | | | | | | | | |
| Comparative | Pure Silver | 74.1 | 46.8 | 27.3 | 90.1 | 75.9 | 14.2 | 95.0 | 84.1 | 10.9 |
| Example 5 | | | | | | | | | | |
| Comparative | Ag—C | 65.5 | 62.5 | 3.0 | 85.1 | 84.6 | 0.5 | 91.8 | 91.5 | 0.3 |
| Example 6 | | | | | | | | | | |
| Comparative | Ag—Sm—Cu | 71.4 | 69.9 | 1.5 | 90.4 | 90.2 | 0.2 | 94.6 | 94.6 | 0.0 |
| Example 7 | | | | | | | | | | |
| Comparative | Ag—Bi—Nd | 71.1 | 68.3 | 2.8 | 90.4 | 89.9 | 0.5 | 94.8 | 94.7 | 0.1 |
| Example 8 | | | | | | | | | | |

As can be seen from Table 3, the pure silver film in Comparative Example 5 has the highest initial reflectance but the reflectance is markedly deteriorated due to the patterning process. This is because the film is exposed to the high temperature in the resist baking process in the patterning process or is exposed to an organic solvent in the resist removing process.

Among the single-layered silver alloy films, the Ag—C alloy film in Comparative Example 6 has initial reflectance much lower than that of the pure silver film. The Ag—Sm—Cu alloy film in Comparative Example 7 and the Ag—Bi—Nd alloy film in Comparative Example 8 exhibit reflectance closer to the pure silver film than the Ag—C alloy film, but is low in initial reflectance at 400 nm. The Ag—Sm—Cu alloy film in Comparative Example 7 and the Ag—Bi—Nd alloy film in Comparative Example 8 exhibit the reflectance higher than those of the pure silver film and the Ag—C alloy film after the patterning process.

On the other hand, in Example 3 in which the pure silver film and the Ag—Sm—Cu alloy film are stacked and Example 4 in which the pure silver film and the Ag—Bi—Nd alloy film are stacked, the characteristics thereof are more excellent than those of Comparative Examples 5 to 8. That is, the initial reflectance of the stacked films in Example 3 and Example 4 is higher than those of the single-layered silver alloy film in Comparative Example 7 or Comparative Example 8 and is close to that of the pure silver film in Comparative Example 5. In addition, the reflectance of the stacked films in Example 3 and Example 4 after the patterning process is high and the variation relative to the initial reflectance is small. The reflectance of the stacked films in Example 3 and Example 4 after the patterning process is higher in any wavelength than that of the pure silver film and is particularly higher in a short wavelength side (400 nm) than that of the single-layered alloy film.

As a result, it can be seen that the initial reflectance and the reflectance after the patterning process are higher by employing the stacked film of the pure silver film and the silver alloy film as in Example 3 and Example 4. This is because the high reflectance can be achieved due to the pure silver film and the deterioration in reflectance after the patterning process is suppressed by stacking the silver alloy film excellent in patterning process resistance on the pure silver film. By setting the thickness of the pure silver film to three times the thickness of the silver alloy film, it is thought that the high reflectance is achieved.

2-2.

As Reference Examples 10 to 18, the patterning process resistance of the silver alloy films according to Reference Examples 1 to 9 in addition to the silver alloy films used in Examples 3 and 4 is evaluated. The film structures thereof are shown in Table 4.

Similarly to the above-mentioned evaluation of the patterning process resistance, the silver alloy films are formed on a smooth glass substrate by the use of a sputtering method using target materials having the compositions.

Similarly to the evaluation of the patterning process resistance, the initial reflectance after the formation and the reflectance after the patterning process are compared and evaluated.

TABLE 4
Wavelength

| | | 400 nm | | | 550 nm | | | 700 nm | | |
|---|---|---|---|---|---|---|---|---|---|---|
| | | Initial | Reflectance | | Initial | Reflectance | | Initial | Reflectance | |
| | | Reflect- | after | Variation in | Reflect- | after | Variation in | Re- | after | Variation in |
| | | ance | Patterning | Reflectance | ance | Patterning | Reflectance | flectance | Patterning | Reflectance |
| | Film Structure | [%] | process [%] | [%] | [%] | process [%] | [%] | [%] | process [%] | [%] |
| Reference | Ag—Au | 64.4 | 56.6 | 7.8 | 86.4 | 83.6 | 2.8 | 92.7 | 90.8 | 1.9 |
| Example 10 | | | | | | | | | | |
| Reference | Ag—Cu | 66.2 | 62.6 | 3.6 | 88.1 | 86.9 | 1.2 | 92.9 | 91.6 | 1.3 |
| Example 11 | | | | | | | | | | |
| Reference | Ag—Au—Cu | 63.0 | 57.5 | 5.5 | 85.3 | 83.2 | 2.1 | 92.4 | 91.7 | 0.7 |
| Example 12 | | | | | | | | | | |
| Reference | Ag—Si—Cu | 70.1 | 66.7 | 3.4 | 89.7 | 88.7 | 1.0 | 93.8 | 92.8 | 1.0 |
| Example 13 | | | | | | | | | | |
| Reference | Ag—P—Cu | 63.9 | 59.8 | 4.1 | 86.2 | 83.9 | 2.3 | 91.8 | 90.1 | 1.7 |
| Example 14 | | | | | | | | | | |
| Reference | Ag—P—In—Cu | 61.4 | 59.2 | 2.2 | 84.5 | 83.2 | 1.3 | 90.8 | 89.6 | 1.2 |
| Example 15 | | | | | | | | | | |
| Reference | Ag—Te—Cu | 60.1 | 58.5 | 1.6 | 79.5 | 79.5 | 0.0 | 86.1 | 86.1 | 0.0 |
| Example 16 | | | | | | | | | | |
| Reference | Ag—Ga—Cu | 56.7 | 52.2 | 4.5 | 80.7 | 79.7 | 1.0 | 88.5 | 87.2 | 1.3 |
| Example 17 | | | | | | | | | | |
| Reference | Ag—In—Sn | 66.5 | 63.6 | 2.9 | 87.4 | 86.0 | 1.4 | 92.2 | 90.7 | 1.5 |
| Example 18 | | | | | | | | | | |

As can be seen from Table 4, the variations in reflectance of the silver alloy films according to Reference Examples 10 to 18 are smaller than that of the single-layered pure silver film in Comparative Example 5. Accordingly, by stacking the silver alloy films according to the reference examples on the pure silver film, it is guessed that it is possible to suppress the deterioration in reflectance after the patterning process. Among these, the Ag—Si—Cu alloy film according to Reference Example 13 is higher in reflectance after the patterning process in any wavelength than the Ag—C alloy film in Comparative Example 6 and exhibits the reflectance equivalent to those of the silver alloy films in Comparative Example 7 and Comparative Example 8. As a result, it is guessed that it is possible to achieve the same advantages of suppressing the deterioration in reflectance after the patterning process as described in Example 3 or Example 4 by stacking the silver alloy film according to Reference Example 13 on the pure silver film.

As described above, by stacking the pure silver film and the silver alloy film, it can be seen that the initial reflectance can be made to approach that of the single-layered pure silver film. It can also be seen that it is possible to greatly suppress the deterioration in reflectance after the high-temperature test and after the patterning process, compared with the single-layered pure silver film. Accordingly, it can be seen that a wavelength-variable interference filter (etalon) employing a pair of reflective films formed by stacking the pure silver film and the silver alloy film is suppressed from the deterioration in performance. It can also be seen that it is possible to suppress the deterioration in performance due to the time-dependent change after shipping the wavelength-variable interference filter as a product, thereby achieving a wavelength-variable interference filter with high reliability.

The entire disclosure of Japanese Patent Application No. 2010-182939, filed Aug. 18, 2010 is expressly incorporated by reference herein.

What is claimed is:

1. An interference filter comprising:
two reflective films that are opposed to each other with a gap interposed therebetween; and
substrates that support the corresponding reflective films,
wherein the reflective films each include a pure silver film and a silver alloy film,
wherein the pure silver film and the silver alloy film are formed on the corresponding substrate sequentially from the substrate, and
wherein the silver alloy film is one of an Ag—Sm—Cu alloy film containing silver (Ag), samarium (Sm), and copper (Cu) and an Ag—Bi—Nd alloy film containing silver (Ag), bismuth (Bi), and neodymium (Nd).

2. An interference filter comprising:
two reflective films that are opposed to each other with a gap interposed therebetween; and
substrates that support the corresponding reflective films,
wherein the reflective films each include a pure silver film and a silver alloy film,
wherein the pure silver film and the silver alloy film are formed on the corresponding substrate sequentially from the substrate, and
wherein the silver alloy film is one of an Ag—Au alloy film containing silver (Ag) and gold (Au), an Ag—Cu alloy film containing silver (Ag) and copper (Cu), an Ag—Au—Cu alloy film containing silver (Ag), gold (Au), and copper (Cu), an Ag—Si—Cu alloy film containing silver (Ag), silicon (Si), and copper (Cu), an Ag—P—Cu alloy film containing silver (Ag), phosphorus (P), and copper (Cu), an Ag—P—In—Cu alloy film containing silver (Ag), phosphorus (P), indium (In), and copper (Cu), an Ag—Te—Cu alloy film containing silver (Ag), tellurium (Te), and copper (Cu), an Ag—Ga—Cu alloy film containing silver (Ag), gallium (Ga), and copper (Cu), and an Ag—In—Sn alloy film containing silver (Ag), indium (In), and tin (Sn).

3. The interference filter according to claim 1, wherein the thickness of each reflective film is in the range of 30 nm to 80 nm, and
wherein the thickness of the silver alloy film is equal to or greater than 10 nm.

4. The interference filter according to claim 1, wherein the silver alloy film is an Ag—Sm—Cu alloy film, and
wherein the Sm content in the Ag—Sm—Cu alloy film is in the range of 0.1 at % to 0.5 at %, the Cu content is in the range of 0.1 at % to 0.5 at %, and the total content of Sm and Cu is equal to or less than 1 at %.

5. The interference filter according to claim 1, wherein the silver alloy film is an Ag—Bi—Nd alloy film, and
wherein the Bi content in the Ag—Bi—Nd alloy film is in the range of 0.1 at % to 3 at % and the Nd content is in the range of 0.1 at % to 5 at %.

6. The interference filter according to claim 1, wherein the each silver alloy film of the reflective film have the same chemical composition.

7. The interference filter according to claim 2, wherein when the silver alloy film is the Ag—Au alloy film, the Au content is in the range of 0.1 at % to 10 at %,
wherein when the silver alloy film is the Ag—Cu alloy film, the Cu content is in the range of 0.1 at % to 10 at %,
wherein when the silver alloy film is the Ag—Au—Cu alloy film, the Au content is equal to or greater than 0.1 at %, the Cu content is equal to or greater than 0.1 at %, and the total content of Au and Cu is equal to or less than 10 at %,
wherein when the silver alloy film is the Ag—Si—Cu alloy film, the Si content is equal to or greater than 0.1 at %, the Cu content is equal to or greater than 0.1 at %, and the total content of Si and Cu is equal to or less than 10 at %,
wherein when the silver alloy film is the Ag—P—Cu alloy film, the P content is equal to or greater than 0.1 at %, the Cu content is equal to or greater than 0.1 at %, and the total content of P and Cu is equal to or less than 10 at %,
wherein when the silver alloy film is the Ag—P—In—Cu alloy film, the P content is equal to or greater than 0.1 at %, the In content is equal to or greater than 0.1 at %, the Cu content is equal to or greater than 0.1 at %, and the total content of P, In, and Cu is equal to or less than 10 at %,
wherein when the silver alloy film is the Ag—Te—Cu alloy film, the Te content is equal to or greater than 0.1 at %, the Cu content is equal to or greater than 0.1 at %, and the total content of Te and Cu is equal to or less than 10 at %,
wherein when the silver alloy film is the Ag—Ga—Cu alloy film, the Ga content is equal to or greater than 0.1 at %, the Cu content is equal to or greater than 0.1 at %, and the total content of Ga and Cu is equal to or less than 10 at %, and
wherein when the silver alloy film is the Ag—In—Sn alloy film, the In content is equal to or greater than 0.1 at %, the Sn content is equal to or greater than 0.1 at %, and the total content of In and Sn is equal to or less than 10 at %.

8. The interference filter according to claim 1, wherein each of the reflective films includes a dielectric film, the pure silver film, and the silver alloy film, and
wherein the dielectric film, the pure silver film, and the silver alloy film are stacked on the corresponding substrate sequentially from the substrate.

9. The interference filter according to claim 7, wherein the dielectric film is one of a single-layered film of titanium oxide (TiO₂) and a multi-layered film in which a layer of titanium oxide (TiO₂) or tantalum pentoxide (Ta₂O₅) and a layer of silicon oxide (SiO₂) or magnesium fluoride (MgF₂) are stacked.

10. The interference filter according to claim 7, wherein each of the reflective films includes the dielectric film, the pure silver film, the silver alloy film, and a protective film, and
wherein the dielectric film, the pure silver film, the silver alloy film, and the protective film are stacked on the corresponding substrate sequentially from the substrate.

11. The interference filter according to claim 9, wherein the protective film contains one of silicon oxide (SiO₂), silicon oxynitride (SiON), silicon nitride (SiN), and alumina.

12. An optical module comprising:
the interference filter according to claim 1; and
a detection unit that detects light intensity of light extracted by the interference filter.

13. An analysis device comprising:
the optical module according to claim 11; and
a processing unit that performs an optical analysis process on the basis of the light intensity of light detected by the detection unit.

14. An interference filter comprising:
reflector;
substrate that support the reflector,
wherein a pure silver and a silver alloy are stacked on the substrate sequentially from the substrate as the reflector, and
wherein the silver alloy is one of an Ag—Sm—Cu alloy containing silver (Ag), samarium (Sm), and copper (Cu) and an Ag—Bi—Nd alloy containing silver (Ag), bismuth (Bi), and neodymium (Nd).

15. An interference filter comprising:
reflector;
substrate that support the reflector,
wherein a pure silver and a silver alloy are stack on the substrate sequentially from the substrate as the reflector, and
wherein the silver alloy is one of an Ag—Au alloy containing silver (Ag) and gold (Au), an Ag—Cu alloy containing silver (Ag) and copper (Cu), an Ag—Au—Cu alloy containing silver (Ag), gold (Au), and copper (Cu), an Ag—Si—Cu alloy containing silver (Ag), silicon (Si), and copper (Cu), an Ag—P—Cu alloy containing silver (Ag), phosphorus (P), and copper (Cu), an Ag—P—In—Cu alloy containing silver (Ag), phosphorus (P), indium (In), and copper (Cu), an Ag—Te—Cu alloy containing silver (Ag), tellurium (Te), and copper (Cu), an Ag—Ga—Cu alloy containing silver (Ag), gallium (Ga), and copper (Cu), and an Ag—In—Sn alloy containing silver (Ag), indium (In), and tin (Sn).
